(19) United States
(12) Patent Application Publication
(10) Pub. No.: US 2020/0019106 A1
(43) Pub. Date: Jan. 16, 2020

(54) IMAGE FORMING APPARATUS AND RECORDING MEDIUM

(71) Applicant: KONICA MINOLTA, INC., Tokyo (JP)

(72) Inventor: Tatsuya NAKANO, Sagamihara-shi (JP)

(73) Assignee: KONICA MINOLTA, INC., Tokyo (JP)

(21) Appl. No.: 16/457,386

(22) Filed: Jun. 28, 2019

(30) Foreign Application Priority Data
Jul. 13, 2018 (JP) 2018-132839

(51) Int. Cl. G03G 15/00; B65H 35/00

(52) U.S. Cl. CPC G03G 15/6523; B65H 35/0006

(57) ABSTRACT

An image forming apparatus includes an image former that forms images on a sheet, a cutter that cuts the sheet on which images are formed by the image former, and generates a plurality of effective sheets that respectively become pages, and a hardware processor that acquires sheet information of each of the plurality of effective sheets that are generated by the cutter, and individually controls conveyance destinations of the plurality of effective sheets based on the sheet information.

### BACKGROUND

### Technological Field

The present invention relates to an image forming apparatus and a recording medium.

### Description of the Related Art

Conventionally, bookbinding processing and the like have been performed by an image forming apparatus that forms images on sheets, and a post processing device that cuts end edge portions of a sheet bundle that is produced by applying post processing to a plurality of sheets on which images are formed (refer to Japanese Patent Laid-Open No. 2008-73776, for example).

Incidentally, in an image forming apparatus, it is more productive to form images of two sheets on one large sheet rather than forming the images on two sheets, and has an advantage of being capable of reducing the number of times of replenishing a sheet feed tray with sheets. Consequently, on performing bookbinding processing or the like that results in a large number of pages, there is a request to perform image formation of a plurality of pages on a large sheet and cut the sheet into the respective pages in the post process.

To the request like this, the images of a plurality of pages are formed on a large sheet, and the sheet is manually set to an off-line cutting machine and is cut, but in this method, a working load is exerted on a user who sets the sheet to the cutting machine, so that development of a device is being advanced, which cuts the sheet on which the images of a plurality of pages are formed in-line, and can generate a plurality of effective sheets to be the respective pages.

On the other hand, in a conventional image forming apparatus, one sheet discharge destination is set to one sheet on which an image is formed, and therefore even if a plurality of effective sheets are generated by cutting in-line, it is necessary to sort the effective sheets because the effective sheets are mixed up after sheet discharge. If the sheets are to be sorted manually, it becomes a working load on the user, so that the technique of sorting and accumulating a plurality of effective sheets when the plurality of effective sheets are generated is also desired.

### SUMMARY

The problem of the present invention is to enable an operation of generating a plurality of effective sheets by cutting a sheet on which images are formed, and sorting the generated plurality of effective sheets to be executed without exerting a working load on a user.

To achieve at least one of the abovementioned objects, according to a first aspect of the present invention, an image forming apparatus reflecting one aspect of the present invention comprises

an image forming apparatus including

an image former that forms images on a sheet,

a cutter that cuts a sheet on which images are formed by the image former, and generates a plurality of effective sheets that respectively become pages, and

a hardware processor that acquires sheet information of each of the plurality of effective sheets that are generated by the cutter, and individually controls conveyance destinations of the plurality of effective sheets based on the sheet information.

According to a second aspect of the present invention, a recording medium reflecting one aspect of the present invention comprises

a non-transitory computer-readable recording medium storing a program for causing a computer of an image forming apparatus including

an image former that forms an image on a sheet, and

a cutter that cuts a sheet on which images are formed by the image former, and generates a plurality of effective sheets that respectively become pages,

to acquire sheet information of each of the plurality of effective sheets that are generated by the cutter, and

to control conveyance destinations of the plurality of effective sheets individually based on the sheet information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram illustrating an entire configuration of an image forming apparatus;

FIG. 2 is a block diagram illustrating a functional configuration of the image forming apparatus;

FIG. 3 is a flowchart illustrating cutting and accumulating processing; and

FIG. 4 is a diagram for explaining a flow of sheets by the cutting and accumulating processing.

### DETAILED DESCRIPTION OF EMBODIMENTS

Hereinafter, one or more embodiment of the present invention will be described with reference to the drawings. However, the scope of the invention is not limited to the disclosed embodiments.

[Configuration of Image Forming Apparatus]

First, a configuration of an image forming apparatus 1 according to the present embodiment will be described.

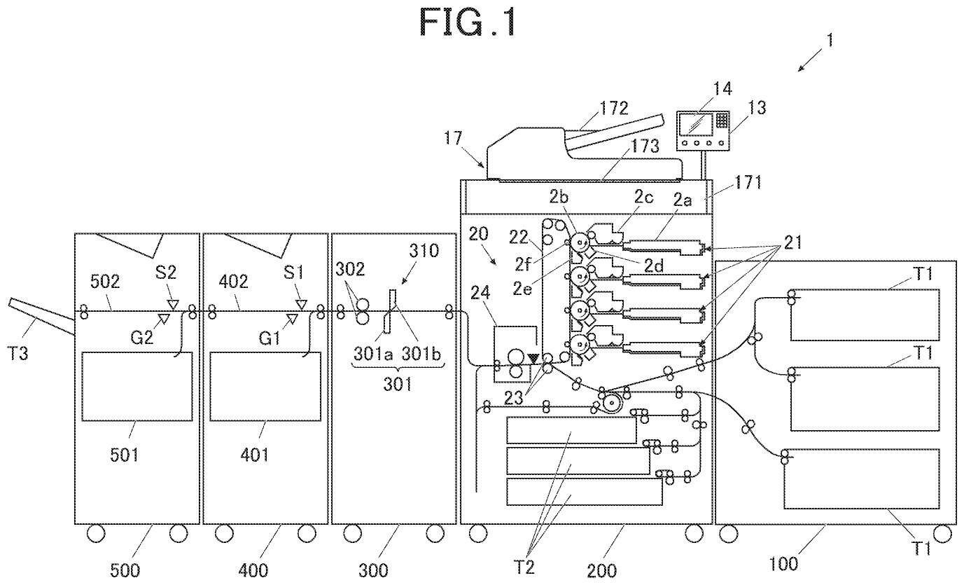

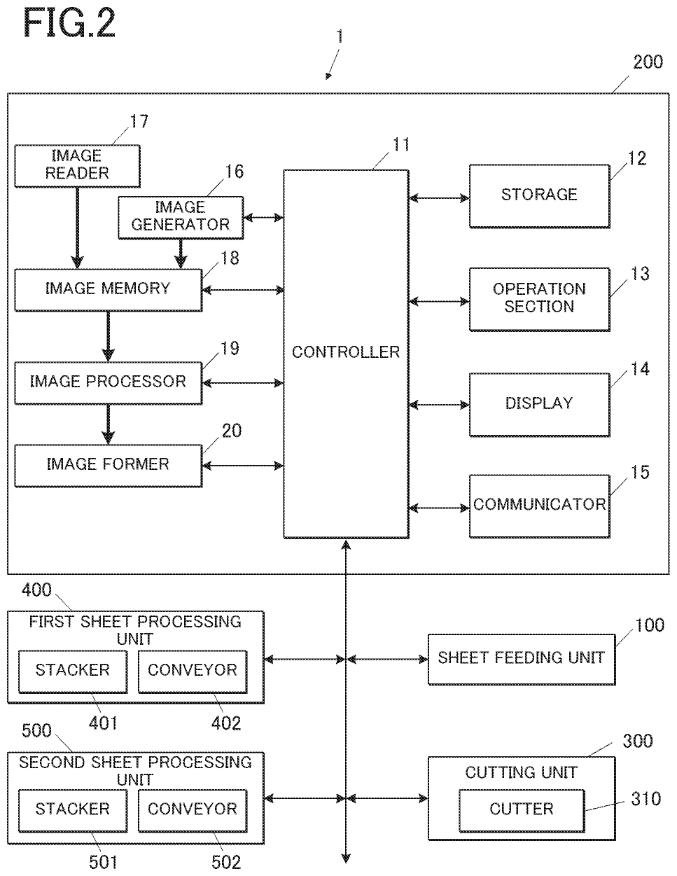

FIG. 1 is a schematic configurational diagram of the image forming apparatus 1. Further, FIG. 2 is a block diagram illustrating a main configuration of the image forming apparatus 1 according to functions.

As shown in FIGS. 1 and 2, the image forming apparatus 1 includes a sheet feeding unit 100, an apparatus main body 200, a cutting unit 300, a first sheet processing unit 400, a second sheet processing unit 500 and the like, and is of a tandem configuration in which these respective units are connected in series along a sheet conveying direction.

Note that in the present embodiment, the number of sheet processing units which are connected is explained as two, but the number of sheet processing units may be three or more.

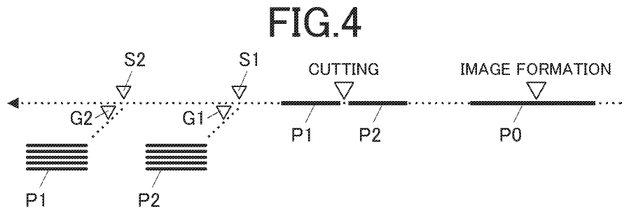

In the image forming apparatus 1 of the present embodiment, it is possible to cut a sheet P0 (refer to FIG. 4) on which images are formed by the apparatus main body 200 into two by the cutting unit 300, and convey sheets P1 and P2 (refer to FIG. 4) that are generated by cutting to the first sheet processing unit 400 and the second sheet processing unit 500 to stack the sheets P1 and P2 respectively.

[Sheet Feeding Unit]

The sheet feeding unit 100 includes a plurality of sheet feeding trays T1, as illustrated in FIG. 1, and conveys sheets P0 stored in the respective sheet feeding trays T1 to the apparatus main body 200 to feed the sheets.

[Apparatus Main Body]

As illustrated in FIG. 1, the apparatus main body 200 includes an image former 20, and forms images on the sheet P0 by the image former 20. The sheets P0 which are used can be fed from either of the sheet feeding tray T1 of the sheet feeding unit 100 and the sheet feeding tray T2 included inside the apparatus main body 200.

As illustrated in FIG. 2, the apparatus main body 200 is configured by including, for example, a controller 11, a storage 12, an operation section 13, a display 14, a communicator 15, an image generator 16, an image reader 17, an image memory 18, an image processor 19, the image former 20 and the like.

The controller 11 is configured by including a CPU (Central Processing Unit), a RAM (Random Access Memory) and the like, and controls respective components of the image forming apparatus 1 by reading various programs from the storage 12 and executing the programs.

For example, the controller 11 controls respective components of the apparatus main body 200 to cause the components to form images on the sheet P0. Further, the controller 11 controls respective components of the cutting unit 300 to cause the components to cut the sheet P0. Further, the controller 11 controls respective components of the first sheet processing unit 400 and the second sheet processing unit 500, and causes the components to convey the sheet P1 and the sheet P2 which are generated by cutting to respective sheet discharge destinations to accumulate the sheet P1 and the sheet P2.

The storage 12 stores programs which are readable by the controller 11 or the like, and files or the like that are used at times of execution of the programs. As the storage 12, a large capacity memory such as a hard disk can be used.

The operation section 13 and the display 14 are user interfaces that are provided at an pper portion of the apparatus main body 200, as illustrated in FIG. 1.

The operation section 13 generates an operation signal corresponding to an operation of a user, and outputs the operation signal to the controller 11. As the operation section 13, a key pad, a touch panel configured integrally with the display 14 and the like can be used.

The display 14 displays an operation screen or the like in accordance with an instruction of the controller 11. As the display 14, an LCD (Liquid Crystal Display), OELD (Organic Electro Luminescence Display) and the like can be used.

For example, the operation section 13 and the display 14 are used when the user sets an image forming mode to the sheet P0. The image forming mode includes, for example, a repeat mode, an intensive mode and the like. The repeat mode is a mode of forming a plurality of images that are identical to one another on a same surface of the sheet P0. The intensive mode is a mode of forming a plurality of images that are different from one another on the same surface of the sheet P0.

Further, the operation section 13 and the display 14 are used when the user sets presence or absence of execution of cutting processing of cutting the sheet P0. At this time, setting can be also performed with respect to respective sizes of the sheets P1 and P2 that are generated by cutting of the sheet P0, sheet discharge destinations, post processing to be executed on the respective sheets P1 and P2, ON/Off of automatic switching of the sheet discharge destinations and the like.

Various set matters that are set based on the user set operation like this are added to job information on image forming job.

The communicator 15 communicates with external apparatuses on the network, for example, a user terminal, a server, other image forming apparatuses and the like.

The communicator 15 receives job information on image forming job including data (hereinafter, referred to as PDL data) in which instruction contents for forming images are described in a page description language (PDL: Page Description Language), from the user terminal or the like via the network.

The job information includes various set matters (image forming mode, presence or absence of execution of the cutting processing, the respective sizes of sheets P1 and P2, the sheet discharge destination, the post processing, ON/OFF of automatic switching of the sheet discharge destination, and the like) when the user performs a setting operation by the user terminal, for example.

The image generator 16 performs rasterizing processing of PDL data received from the communicator 15, and generates image data in a bitmap format.

The image reader 17 reads an original document surface, and generates image data in a bitmap format. As the image reader 17, it is possible to use a scanner 171 that is provided under a platen glass 173 as illustrated in FIG. 1, and it is also possible to include an automatic document reader (ADF: Auto Document Feeder) 172 to automatically feed an original document to the scanner 171.

Here, in the image generator 16 and the image reader 17, in a case where the job information includes setting of the repeat mode or the intensive mode, image data in which images of a plurality of pages are stored is generated to one sheet P0.

When the image data generated by the image generator 16 and the image reader 17 has pixel values of three colors of R (red), G (green), and B (blue), color conversion processing is performed by the controller 11, an exclusive color converter or the like, and after the image data is converted into image data having pixel values of four colors of C (cyan), M (magenta), Y (yellow) and K (black), the image data is held by the image memory 18. The pixel value is a data value expressing a shade of an image, and for example, a data value of eight bits expresses a shade of 0 to 255 gradations.

The image memory 18 is a buffer memory that temporarily retains image data generated by the image generator 16 or the image reader 17. As the image memory 18, DRAM (Dynamic RAM) or the like can be used.

The image processor 19 reads the image data from the image memory 18, and performs various kinds of image processing such as density correction processing, and half tone processing. The density correction processing is processing of converting respective pixel values of image data so that density characteristic of the image on the sheet becomes an intended density characteristic. The half tone processing is processing of reproducing a half tone artificially, like dithering, and error diffusion processing.

The image former 20 forms an image made of four colors on the sheet P0 in accordance with pixel values of four colors of C, M, Y and K of the respective pixels of the image data to which image processing is applied by the image processor 19.

The image former 20 includes four writing units 21, an intermediate transfer belt 22, a secondary transfer roller 23, a fixing device 24, a plurality of sheet feeding trays T2 and the like, as illustrated in FIG. 1.

The four writing units 21 are disposed in series (tandem) along a belt surface of the intermediate transfer belt 22, and form images of respective colors of C, M, Y and K. The respective writing units 21 differ in only the color of images that are formed but have the same configuration, and each includes an exposer 2a, a photoreceptor 2b, a developer 2c, an electrifier 2d, a cleaner 2e and a primary transfer roller 2f as illustrated in FIG. 1.

In each of the writing units 21, after the photoreceptor 2b is electrified by the electrifier 2d, a laser beam modulated based on the image data is emitted in the exposer 2a to scan on the rotating photoreceptor 2b to form an electrostatic latent image. The developer 2c supplies a toner onto the photoreceptor 2b, and develops the electrostatic latent image on the photoreceptor 2b. In this way, the images that are respectively formed on the photoreceptors 2b of the four writing units 21 are sequentially superimposed and transferred (primary transfer) onto the intermediate transfer belt 22 by the respective primary transfer rollers 2f, whereby an image made of the respective colors is formed on the intermediate transfer belt 22. After the primary transfer, the toner remaining on the photoreceptor 2b is removed by the cleaner 2e.

When the sheet P0 is fed from the sheet feeding tray T1 or T2, the image is transferred (secondary transfer) onto the sheet P0 from the intermediate transfer belt 22 by the secondary transfer roller 23, the sheet P0 is heated and pressurized in the fixing device 24, and fixing processing is performed. When images are formed on both sides of the sheet P0, the sheet P0 is conveyed to the conveying path to reverse the sheet surface, after which, the sheet P0 can be conveyed to the secondary transfer roller 23 again.

[Cutting Unit]

The cutting unit 300 includes a cutter 310 and the like, and cuts the sheet P0 which is conveyed from the apparatus main body 200 at a predetermined position by the cutter 310.

The cutter 310 is configured by including a CD cutter 301, a vertical slitter 302 and the like as illustrated in FIG. 1.

The CD cutter 301 extends in a sheet width direction, and cuts the sheet P0 at a predetermined position. The CD cutter 301 has cutting blades 301a and 301b which are disposed so that the blades face each other, and the cutting blades 301a and 300b are respectively plate-shaped members in which longitudinal directions are along the sheet width direction. The cutting blades 301a and 301b swingably move in directions to approach each other by a drive section not illustrated and thereby cut the sheet P0 sandwiched between both the cutting blades 301a and 301b at the predetermined position.

The “predetermined position” is, for example, a position between images when the images of a plurality of pages are formed on the sheet P0, and when the images of two pages are formed, the predetermined position is a center portion or the like in the conveying direction of the sheet P0.

Thereby, the one sheet P0 is cut, and a sheet P1 and a sheet P2 which are two sheets are generated. The sheet P1 and the sheet P2 which are two sheets are each an effective sheet which becomes one page in a product form.

The vertical slitter 302 is a slitter having a pair of round blades in a vertical direction. The vertical slitter 302 is disposed to be capable of cutting both ends in a width direction of the sheet P0, and can cut an end portion in the width direction of the sheet P0 which is sandwiched by both of the round blades, by upper and lower blades respectively rotating as the sheet P0 is conveyed, as ineffective portions to be unnecessary in the product form, in accordance with necessity.

Besides, the cutting unit 300 includes a bending correction roller pair that corrects bending of the sheet P0, a sensor that detects a tip end in the conveying direction of the sheet P0 and the like, and can correctly cut the sheet P0 at the predetermined position.

[First Sheet Processing Unit]

The first sheet processing unit 400 can feed one (the sheet P1 in this case) out of the sheets generated by the cutting processing of the cutting unit 300 to the following second sheet processing unit 500, and stack the other one (the sheet P2), under control of the controller 11.

The first sheet processing unit 400 includes a stacker 401, a conveyor 402, a sheet processor and the like.

The stacker 401 accumulates a plurality of sheets P2.

The stacker 401 is provided with a full state sensor, and when an accumulation amount of the sheets P2 reaches a predetermined amount, the full state sensor detects this and outputs a signal. Thereby, the controller 11 is capable of recognizing that the stacker 401 is in a full state.

The conveyor 402 has, for example, a sheet conveying path, a plurality of conveying rollers that are provided along the sheet conveying path, and the like.

The sheet conveying path is provided with a gate G1 that switches a conveying direction of the sheet which is conveyed on the path, and by drive of the gate G1, the conveying direction of the sheet can be switched to a first direction leading to the second sheet processing unit 500, and a second direction leading to the stacker 401.

Further, the sheet conveying path is provided with a sensor S1 that detects sheets conveyed on the route, and the gate G1 is switched in response to an output signal of the sensor S1.

The sheet processor includes a mechanism that performs sheet processing such as punching processing, binding processing, and folding processing, for example, and performs the sheet processing to the sheets P1 which are stacked on the stacker 401 in accordance with necessity.

Besides, the first sheet processing unit 400 may include other sheet discharge trays, conveying paths that convey the sheets to the other sheet discharge trays and the like.

[Second Sheet Processing Unit]

The second sheet processing unit 500 can stack one (the sheet P1 in this case) of the sheets generated by the cutting processing of the cutting unit 300 under control of the controller 11.

The second sheet processing unit 500 includes a stacker 501, a conveyor 502, a sheet processor and the like.

The stacker 501 accumulates a plurality of sheets P1.

The stacker 501 is provided with a full state sensor, and when the accumulation amount of the sheets P1 reaches a predetermined amount, the full state sensor detects this and outputs a signal. Thereby, the controller 11 is capable of recognizing that the stacker 501 is in a full state.

The conveyor 502 has, for example, a sheet conveying path, a plurality of conveying rollers that are provided along the sheet conveying path, and the like.

The sheet conveying path is provided with a gate G2 that switches a conveying direction of the sheets which are conveyed on the path, and by drive of the gate G2, the conveying direction of the sheets can be switched to a first direction leading to an external sheet discharge tray T3, and a second direction leading to the stacker 501.

Further, the sheet conveying path is provided with a sensor S2 that detects the sheets which are conveyed on the path, and the gate G2 is switched in response to an output signal of the sensor S2.

The sheet processor includes a mechanism that performs sheet processing such as punching processing, binding processing, and folding processing, for example, and performs the sheet processing to the sheets P2 stacked on the stacker 501 in accordance with necessity. Here, the sheet processor of the second sheet processing unit 500 executes the sheet processing which is different from the sheet processing of the sheet processor of the first sheet processing device 400, to the sheets.

Besides, the second sheet processing unit 500 may include other sheet discharge trays, conveying paths that convey the sheets to the other sheet discharge trays and the like.

Note that in the present embodiment, the controller 11 of the apparatus main body 200 performs the operation control of the respective units that configure the image forming apparatus 1 as described above, but such a configuration is an example and the present invention is not limited to this. For example, a control unit for operation control of the image forming apparatus 1 may be additionally provided, or the respective unit may be provided with controllers individually.

[Operation of Image Forming Apparatus]

Next, an operation of the image forming apparatus 1 in the present embodiment will be described.

In the present embodiment, processing (cutting and accumulating processing) of forming two images of two pages on the sheet P0 by the apparatus main body 200, cutting the sheet P0 by the cutting unit 300 to generate the sheets P1 and P2, and conveying the sheets P1 and P2 respectively to the first sheet processing unit 400 and the second sheet processing unit 500 is executed.

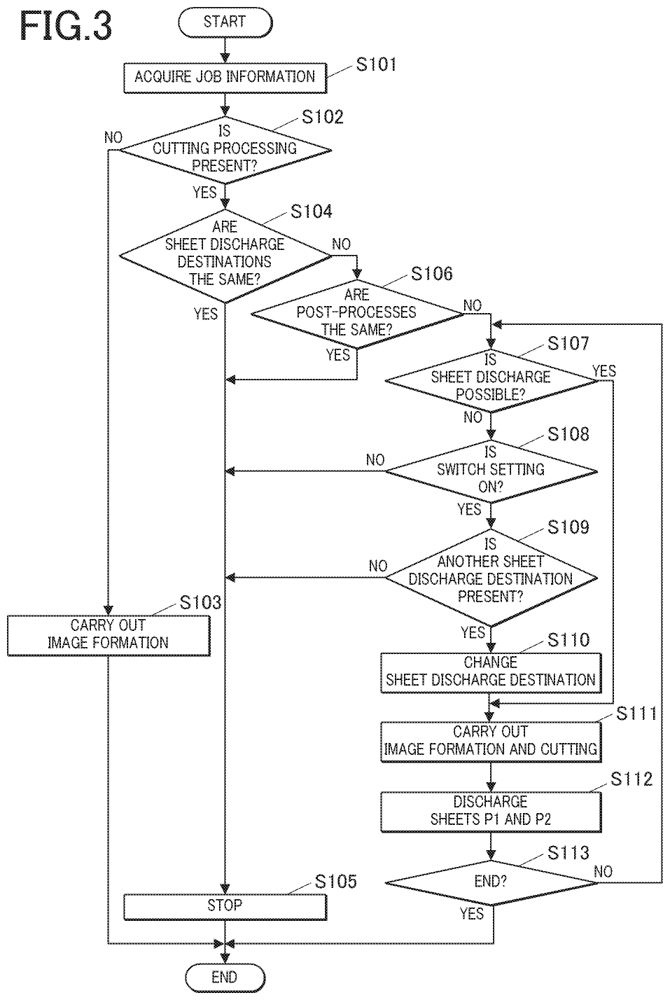

FIG. 3 is a flowchart illustrating a flow of the cutting and accumulating processing as above.

The controller 11 of the image forming apparatus 1 executes the process in accordance with the program stored in the storage 12, with input of an image forming job as a trigger.

First, the controller 11 acquires job information of the image forming job which is inputted (step S101).

The job information includes, for example, the image forming mode, presence or absence of execution of the cutting processing, the cutting position in the case of executing the cutting processing, the sheet information concerning the sheets P1 and P2 that are generated in the case of executing the cutting processing and the like.

The sheet information includes, for example, sizes of the sheets P1 and P2, respective sheet discharge destinations of the sheet P1 and the sheet P2, post processing that is respectively applied to the sheets P1 and P2, ON/OFF of automatic switching of the sheet discharge destination and the like.

Next, the controller 11 determines whether or not execution of the cutting processing is present (step S102).

Subsequently, when execution of the cutting processing is absent (step S102: NO), image forming processing is carried out (step S103), and the present processing is ended.

When execution of the cutting processing is present (step S102: YES), the controller 11 determines whether or not the sheet discharge destinations of the sheets P1 and P2 which are generated are the same (step S104).

When the sheet discharge destinations of the sheets P1 and P2 are the same (step S104: YES), the controller 11 stops the image forming processing (step S105), and ends the present processing.

In other words, the controller 11 stops the image forming processing because the sheet discharge destinations of the sheets P1 and P2 are the same, so that the sheets P1 and P2 are mixed up, and thereby there is a possibility that the sheets P1 and P2 are not established in the product form.

Thereafter, an error is outputted by displaying a message on the display 14 or the like, and when the error is cleared, the image forming processing may be restarted.

When the sheet discharge destinations of the sheets P1 and P2 after cutting are not the same (step S104: NO), the controller 11 determines whether or not the post processes of the sheets P1 and P2 are the same (step S106).

When the post processes of the sheets P1 and P2 are the same (step S106: YES), the controller 11 shifts to step S105 describe above, stops the image forming processing, and ends the present processing.

In other words, the controller 11 considers that correct setting is not made since the sheet discharge destinations of the sheets P1 and P2 are not the same, but the post processes are the same, and stops the image forming processing because there is possibility that the sheets P1 and P2 are not established in the product form.

When the post processes of the sheets P1 and P2 are not the same (step S106: NO), the controller 11 determines whether or not the sheet discharge destinations of the sheets P1 and P2 which are set are not full, and sheet discharge is possible (step S107).

Note that it is detectable that the stackers 401 and 501 are full by the full state sensors provided at the stacker 401 and the stacker 501.

When sheet discharge to the sheet discharge destinations of the sheets P1 and P2 are possible (step S107: YES), the controller 11 shifts to step S111 described later.

When sheet discharge to the sheet discharge destinations of the sheets P1 and P2 is impossible (step S107: NO), the controller 11 determines whether or not setting of automatic switching of the sheet discharge destination which allows switching of the sheet discharge destination is on (step S108).

For example, in a case where it is considered that no problem occurs even when the sheet discharge destination is switched, such as a case where the sheets P1 and P2 are only sorted and accumulated and no post processing is set, automatic switching of the sheet discharge destination is preferably turned on. Setting may be made based on the setting operation by the user, or when setting is not made by the setting operation by the user, the controller 11 may make setting based on whether or not the post processing is set, for example.

When the setting of automatic switching of the sheet discharge destination is off (step S108: NO), the controller 11 shifts to step S105 described above, stops the image forming processing, and ends the present processing.

When setting of the automatic switching of the sheet discharge destination is on (step S108: YES), the controller 11 determines whether or not another sheet discharge destination to which the sheets can be discharged (a sheet discharge tray T3 and the like) is present (step S109), and when there is no other sheet discharge destination (step S109: NO), the controller 11 shifts to step S105 described above, stops the image forming processing, and stops the present processing.

When there is another sheet discharge destination (step S109: YES), the controller 11 changes the sheet discharge destination of the sheet information (step S110).

Next, the controller 11 executes the image forming processing and the cutting processing (step S111).

Here, in response to the job information, two images are formed on the sheet P0 in the apparatus main body 200, the sheet P0 is cut in the cutting unit 300, and the sheets P1 and P2 are generated.

Next, the controller 11 individually controls the sheet discharge destinations of the sheets P1 and P2, and discharges the sheets P1 and P2 to the respective sheet discharge destinations (step S112).

Specifically, as illustrated in FIG. 4, the controller 11 causes the sheet P1 to go straight on the conveying path of the first sheet processing unit 400 to be fed to the second sheet processing unit 500. The sheet P1 that reaches the second sheet processing unit 500 is accumulated on the stacker 501.

When the sensor S1 detects that a rear end of the sheet P1 passes in the conveying path of the first sheet processing unit 400, the gate G1 is driven, and the conveying direction is switched to the second direction from the first direction. Thereby, the following sheet P2 is accumulated on the stacker 401 of the first sheet processing unit 400.

The gate G1 returns to an original position after causing the sheet P2 to advance in the direction of the stacker 401, and can cause the following sheet P1 to go straight.

Note that in this case, the sheet P1 is conveyed and accumulated onto the stacker 501, and the sheet P2 is conveyed and accumulated onto the stacker 401, but it is needless to say that the conveyance destinations of the sheets P1 and P2 are opposite.

Further, it is also possible to convey and accumulate the sheets P1 and P2 onto the same sheet discharge destinations, and in this case, an error is outputted, but it is possible to continue the processing by the setting by clearing the error.

Next, the controller 11 determines whether or not the processing to all the sheets of the job is ended (step S113), and when the processing is not ended (step S113: NO), the controller shifts to step S107 described above, whereas when the processing is ended (step S113: YES), the controller 11 ends the present processing.

For example, when two identical images are formed by being vertically reversed from each other by the above processing (in a case of reversed two repeat images), sheet bundles with the cutting positions of the sheets are aligned at same sides can be made by discharging the sheets to the different sheet discharge destinations after cutting, and quality of the sheet bundles can be enhanced.

Further, for example, when two identical images are formed (in a case of two repeat images), the sheets with the two identical images are discharged to the different sheet discharge destinations after cutting, and thereby different post processes can be performed, in such a manner that one of the sheets is folded into three in a page unit, and the other one is stapled in a job unit. Consequently, in the case of this example, a bundle of the sheets folded into three for DM, and a bundle of stapled sheets for storage can be simultaneously produced.

### Effect According to Present Embodiment

As above, according to the present embodiment, the image forming apparatus 1 includes the image former 20 that forms images on the sheet P0, and the cutter 310 that cuts the sheet P0 on which images are formed by the image former 20, and generates a plurality of sheets P1 and P2 that respectively become pages, and the controller 11 acquires the sheet information on each of the plurality of sheets P1 and P2 generated by the cutter 310, and controls the sheet conveyance destinations of the plurality of sheets P1 and P2 individually based on the sheet information.

Consequently, it becomes possible to execute an operation of generating a plurality of effective sheets by cutting the sheet on which the images are formed, and sorting the plurality of effective sheets which are generated, without exerting a working load on the user.

Further, according to the present embodiment, the sheet information includes at least one of the respective sizes of the plurality of sheets P1 and P2, the sheet discharge destinations, and the post processes to be executed on the respective plurality of sheets P1 and P2.

Consequently, conveyance of the sheets P1 and P2 can be controlled based on at least one of the respective sizes of the plurality of sheets P1 and P2, the sheet discharge destinations, and the post processes to be executed on the respective plurality of sheets P1 and P2.

Further, according to the present embodiment, the controller 11 stops image foi illation by the image former 20 when the sheet discharge destinations of the plurality of sheets P1 and P2 are set to be the same, or the post processes to be executed on the plurality of sheets P1 and P2 are set to be the same according to the sheet information.

Consequently, image formation can be stopped when there is the possibility that the sheets P1 and P2 are not established in the product form.

Further, according to the present embodiment, the controller 11 determines whether or not there is another sheet discharge destination to which the sheets can be discharged when at least one of the sheet discharge destinations of the plurality of sheets P1 and P2 is full, and when there is no other sheet discharge destination, the controller 11 stops image formation by the image former 20.

Consequently, when there is possibility that proper sorting cannot be performed, image formation can be stopped.

Further, according to the present embodiment, the controller 11 acquires the sheet information generated based on the setting operation of the user.

Consequently, the plurality of sheets P1 and P2 are sorted and are subjected to the post processing based on the setting operation of the user, and it becomes possible to produce a product desired by a user with ease.

The embodiment to which the present invention is applicable is not limited to the aforementioned embodiment, and the present invention can be properly changed within the range without departing from the gist of the present invention.

For example, in the above described embodiment, the case of cutting the sheet P0 once (generating the two sheets P1 and P2) is illustrated, but the number of times of cutting is not limited to this. In other words, the number of sheets after cutting is not limited to twos. Note that when cutting is made a plurality of times, it is possible to determine the sheet discharge destinations based on whether the sheets are in an odd position or in an even position as viewed from a front end of the sheet P0.

Further, in the above described embodiment, the configuration in which the sheets P1 and P2 are conveyed to the different sheet discharge destinations based on the setting operation of the user is illustrated, but even when there is not a setting operation of the user, the controller 11 may perform control of conveying the sheets P1 and P2 to the different sheet discharge destinations when a plurality of effective sheets are generated by the cutting processing.

Specifically, the controller 11 acquires the sheet information when the job information includes implementation of the cutting processing, and when the sheet information does not include the respective conveyance destinations of a plurality of effective sheets, the controller 11 sets the conveyance destinations of the plurality of effective sheets so that the conveyance destinations of the plurality of effective sheets differ from each other.

At this time, for example, the sheet discharge destination of a size which is more suitable to a length in the conveying direction of the effective sheet after cutting may be determined. Further, the sheet discharge destination can be determined based on whether the effective sheet corresponds to a first half or a latter half in the conveying direction of the sheet P0 before cutting, or when cutting is performed a plurality of times, the sheet discharge destination can be determined according to whether the effective sheet is in an odd position or in an even position viewed from the front end of the sheet P0.

Further, in the above described embodiment, the sheet information is acquired before cutting of the sheet P0, and based on the sheet information, cutting and conveyance/accumulation are performed, but a configuration in which the sheet information is acquired after the cutting processing is ended may be adopted.

In this case, for example, the controller 11 stops conveyance of the sheets P1 and P2 which are generated (or decreases a conveying speed) after finishing the cutting processing, receives the setting operation of the user, acquires the sheet information, and thereafter restarts conveyance of the sheets P1 and P2 (or restores the conveying speed) to be able to perform control of conveying the sheets P1 and P2 to the respective conveyance destinations, and the like.

In the case of the above control, the user can perform a setting operation after confirming the sheets P1 and P2 which are generated by cutting.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2018-132839, filed on 13t^{h} of July, 2018, is incorporated herein by reference in its entirety.

What is claimed is:

1. An image forming apparatus, comprising:
an image former that forms images on a sheet;
a cutter that cuts a sheet on which images are formed by the image former, and generates a plurality of effective sheets that respectively become pages; and
a hardware processor that acquires sheet information of each of the plurality of effective sheets that are generated by the cutter, and individually controls conveyance destinations of the plurality of effective sheets based on the sheet information.

2. The image forming apparatus according to claim 1,
wherein the sheet information includes at least one of respective sizes of the plurality of effective sheets, sheet discharge destinations, and post processes to be executed on the respective plurality of effective sheets.

3. The image forming apparatus according to claim 1,
wherein the hardware processor stops image formation by the image former when the sheet discharge destinations of the plurality of effective sheets are set to be same, or the post processes to be executed on the plurality of effective sheets are set to be same, according to the sheet information.

4. The image forming apparatus according to claim 1,
wherein the hardware processor determines whether or not another sheet discharge destination to which sheets can be discharged is present when at least one of the sheet discharge destinations of the plurality of effective sheets becomes full, and when the other sheet discharge destination is not present, the hardware processor stops image formation by the image former.

5. The image forming apparatus according to claim 1,
wherein the hardware processor acquires the sheet information that is generated based on a setting operation of a user.

6. The image forming apparatus according to claim 1,
wherein the hardware processor acquires the sheet information when job information includes implementation of cutting processing, and when the sheet information does not include respective conveyance destinations of the plurality of effective sheets, the hardware processor sets the conveyance destinations of the plurality of effective sheets so that the conveyance destinations of the plurality of effective sheets differ from each other.

7. A non-transitory computer-readable recording medium storing a program for causing a computer of an image forming apparatus comprising
an image former that forms images on a sheet, and
a cutter that cuts a sheet on which images are formed by the image former, and generates a plurality of effective sheets that respectively become pages,
to acquire sheet information of each of the plurality of effective sheets that are generated by the cutter, and
to control conveyance destinations of the plurality of effective sheets individually based on the sheet information.
